(19) United States
(12) Patent Application Publication
(10) Pub. No.: US 2005/0164031 A1
(43) Pub. Date: Jul. 28, 2005

(54) Dual emitting dyads of heavy metal complexes as broad band emitters for organic LEDs

(76) Inventors: Mark E. Thompson, Anaheim, CA (US); Biwu Ma, Los Angeles, CA (US); Peter Djurovich, Los Angeles, CA (US)

Correspondence Address: KENYON & KENYON, ONE BROADWAY, NEW YORK, NY, 10004, US

(21) Appl. No.: 10/807,739

(22) Filed: Mar. 24, 2004

Related U.S. Application Data
(60) Provisional application No. 60/539,210, filed on Jan. 26, 2004.

(51) Int. Cl. H05B 33/14; C09K 11/06

(52) U.S. Cl. 428/690; 428/917; 313/504; 549/3; 546/4; 546/10

(57) ABSTRACT

An organic light emitting device is provided. The device has an anode, a cathode, and an emissive layer disposed between and electrically connected to the anode and the cathode. The emissive layer further comprises a compound having two metal centers, in which each metal has an atomic weight greater than 40. A bridging ligand, small molecule, or polymer is coordinated to both metal centers, and at least one photoactive ligand is bound to each metal. In one embodiment, the transition dipole moment of the photoactive ligand bound to the first metal is orthogonal to the photoactive ligand bound to the second metal. In another embodiment, the first metal center and the atoms of the bridging ligand that are coordinated to the first metal center form a plane and the atoms of the bridging ligand that are coordinated to the second metal center form another plane, and the planes form an angle that is between about 80 degrees and 100 degrees. In another embodiment, the bridging ligand is diacetylacetonate. In another embodiment, a polymer or small molecule is coordinated to both metals, and the metal-ligand complex for the first metal center is different from the metal-ligand complex for the second metal center.

This application is related to and claims priority from U.S. Provisional Patent Application 60/539,210, filed Jan. 26, 2004, which is incorporated by reference in its entirety.

### FIELD OF THE INVENTION

The present invention relates to organic light emitting devices (OLEDs), and specifically to phosphorescent organic materials used in such devices. More specifically, the present invention relates to OLEDs in which the emissive layer comprises a phosphorescent emitting material having two metal centers.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be an fluorescent or phosphorescent small molecule emitter. A dendrimer may be a “small molecule,” and it is believed that all dendrimers currently used in the field of OLEDs are small molecules.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

OLED devices are generally (but not always) intended to emit light through at least one of the electrodes, and one or more transparent electrodes may be useful in an organic opto-electronic devices. For example, a transparent electrode material, such as indium tin oxide (ITO), may be used as the bottom electrode. A transparent top electrode, such as disclosed in U.S. Pat. Nos. 5,703,436 and 5,707,745, which are incorporated by reference in their entireties, may also be used. For a device intended to emit light only through the bottom electrode, the top electrode does not need to be transparent, and may be comprised of a thick and reflective metal layer having a high electrical conductivity. Similarly, for a device intended to emit light only through the top electrode, the bottom electrode may be opaque and/or reflective. Where an electrode does not need to be transparent, using a thicker layer may provide better conductivity, and using a reflective electrode may increase the amount of light emitted through the other electrode, by reflecting light back towards the transparent electrode. Fully transparent devices may also be fabricated, where both electrodes are transparent. Side emitting OLEDs may also be fabricated, and one or both electrodes may be opaque or reflective in such devices.

As used herein, “top” means furthest away from the substrate, while “bottom” means closest to the substrate. For example, for a device having two electrodes, the bottom electrode is the electrode closest to the substrate, and is generally the first electrode fabricated. The bottom electrode has two surfaces, a bottom surface closest to the substrate, and a top surface further away from the substrate. Where a first layer is described as “disposed over” a second layer, the first layer is disposed further away from substrate. There may be other layers between the first and second layer, unless it is specified that the first layer is “in physical contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

One application for phosphorescent emissive molecules is a full color display. Industry standards for such a display call for pixels adapted to emit particular colors, referred to as “saturated” colors. In particular, these standards call for saturated red, green, and blue pixels. Color may be measured using CIE coordinates, which are well known to the art.

Industry standards call for the lifetime of such full color displays to be at least about 5000 hours. In addition, high stability and efficiency are important characteristics of high quality displays. These requirements have helped generate a need for phosphorescent emissive materials that exhibit longer lifetimes, higher stability, and higher efficiency in the red, green and blue wavelength regimes than have been achieved in the prior art.

One example of a green emissive molecule is tris(2-phenylpyridine) iridium, denoted Ir(ppy)₃, which has following structure:

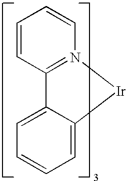

In this, and later figures herein, we depict the dative bond from nitrogen to metal (here, Ir) as a straight line. Ir(ppy)₃ emits a spectrum at CIE 0.30, 0.63, and has a halflife of about 10,000 hours at an initial luminance of 500 cd/m², and a quantum efficiency of about 6%. Kwong et al., Appl. Phys. Lett., 81, 162 (2002).

### SUMMARY OF THE INVENTION

An organic light emitting device is provided. The device has an anode, a cathode, and an emissive layer disposed between and electrically connected to the anode and the cathode. The emissive layer further comprises a compound having two metal centers, in which each metal has an atomic weight greater than 40. A bridging ligand, small molecule, or polymer is coordinated to both metal centers, and at least one photoactive ligand is bound to each metal. In one embodiment, the transition dipole moment of the photoactive ligand bound to the first metal is orthogonal to the photoactive ligand bound to the second metal. In another embodiment, the first metal center and the atoms of the bridging ligand that are coordinated to the first metal center form a plane and the atoms of the bridging ligand that are coordinated to the second metal center form another plane, and the planes form an angle that is between about 80 degrees and 100 degrees. In another embodiment, the bridging ligand is diacetylacetonate. In another embodiment, a polymer or small molecule is coordinated to both metals, and the metal-ligand complex for the first metal center is different from the metal-ligand complex for the second metal center.

### BRIEF DESCRIPTION OF THE DRAWINGS

FIG. 1 shows an organic light emitting device having separate electron transport, hole transport, and emissive layers, as well as other layers.

FIG. 2 shows an inverted organic light emitting device that does not have a separate electron transport layer.

FIG. 3 shows the ¹H NMR spectra for DiFPt.

FIG. 4 shows the ¹H NMR spectra for DiTpy.

FIG. 5 shows the ¹H NMR spectra for FPt-Tpy.

FIG. 6 shows the emission spectra at room temperature for DiFPt and its mononuclear component.

FIG. 7 shows the emission spectra at 77 K for FPt and PQPt and its mononuclear component.

FIG. 8 shows the emission spectra at room temperature for FPt-PQPt. FPt-PQPt exhibits dual emission at peak wavelengths of 464 nm (0.17 μs lifetime) and 572 nm (5.05 μs lifetime).

FIG. 9 shows the emission spectra at 77 K for FPt-PQPt. FPt-PQPt exhibits dual emission at peak wavelengths of 456 nm (6.12 μs lifetime) and 542 nm (7.24 μs lifetime).

FIG. 10 shows the emission spectra for FPt-PQPt at different excitations at 77K.

FIG. 11 shows the emission spectra for FPt-PQPt in polystyrene at room temperature.

FIG. 12 shows the emission spectra at 77 K for FPt-PQIr.

FIG. 13 shows the emission spectra at 77 K for FIr-PQIr.

FIG. 14 shows the emission spectra at 77 K for FIr-PQPt.

FIG. 15 shows the crystal structure of FPt-Tpy.

### DETAILED DESCRIPTION

Generally, an OLED comprises at least one organic layer disposed between and electrically connected to an anode and a cathode. As used herein, the term “disposed between and electrically connected to” does not indicate that the recited layers are necessarily adjacent and in direct contact. Rather, it allows for the disposition of additional layers between the recited layers. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), which are incorporated by reference in their entireties. Phosphorescence may be referred to as a “forbidden” transition because the transition requires a change in spin states, and quantum mechanics indicates that such a transition is not favored. As a result, phosphorescence generally occurs in a time frame exceeding at least 10 nanoseconds, and typically greater than 100 nanoseconds. If the natural radiative lifetime of phosphorescence is too long, triplets may decay by a non-radiative mechanism, such that no light is emitted. Organic phosphorescence is also often observed in molecules containing heteroatoms with unshared pairs of electrons at very low temperatures. 2,2′-bipyridine is such a molecule. Non-radiative decay mechanisms are typically temperature dependent, such that a material that exhibits phosphorescence at liquid nitrogen temperatures may not exhibit phosphorescence at room temperature. But, as demonstrated by Baldo, this problem may be addressed by selecting phosphorescent compounds that do phosphoresce at room temperature. Representative emissive layers include doped or un-doped phosphorescent organo-metallic materials such as disclosed in U.S. Pat. Nos. 6,303,238 and 6,310,360; U.S. Patent Application Publication Nos. 2002-0034656; 2002-0182441; and 2003-0072964; and WO-02/074015.

Generally, the excitons in an OLED are believed to be created in a ratio of about 3:1, i.e., approximately 75% triplets and 25% singlets. See, Adachi et al., “Nearly 100% Internal Phosphorescent Efficiency In An Organic Light Emitting Device,” J. Appl. Phys., 90, 5048 (2001), which is incorporated by reference in its entirety. In many cases, singlet excitons may readily transfer their energy to triplet excited states via “intersystem crossing,” whereas triplet excitons may not readily transfer their energy to singlet excited states. As a result, 100% internal quantum efficiency is theoretically possible with phosphorescent OLEDs. In a fluorescent device, the energy of triplet excitons is generally lost to radiationless decay processes that heat-up the device, resulting in much lower internal quantum efficiencies. OLEDs utilizing phosphorescent materials that emit from triplet excited states are disclosed, for example, in U.S. Pat. No. 6,303,238, which is incorporated by reference in its entirety.

Phosphorescence may be preceded by a transition from a triplet excited state to an intermediate non-triplet state from which the emissive decay occurs. For example, organic molecules coordinated to lanthanide elements often phosphoresce from excited states localized on the lanthanide metal. However, such materials do not phosphoresce directly from a triplet excited state but instead emit from an atomic excited state centered on the lanthanide metal ion. The europium diketonate complexes illustrate one group of these types of species.

Phosphorescence from triplets can be enhanced over fluorescence by confining, preferably through bonding, the organic molecule in close proximity to an atom of high atomic number. This phenomenon, called the heavy atom effect, is created by a mechanism known as spin-orbit coupling. Such a phosphorescent transition may be observed from an excited metal-to-ligand charge transfer (MLCT) state of an organometallic molecule such as tris(2-phenylpyridine)iridium(III).

As used herein, the term “triplet energy” refers to energy corresponding to the highest energy feature discernable in the phosphorescence spectrum of a given material. The highest energy feature is not necessarily the peak having the greatest intensity in the phosphorescence spectrum, and could, for example, be a local maximum of a clear shoulder on the high energy side of such a peak.

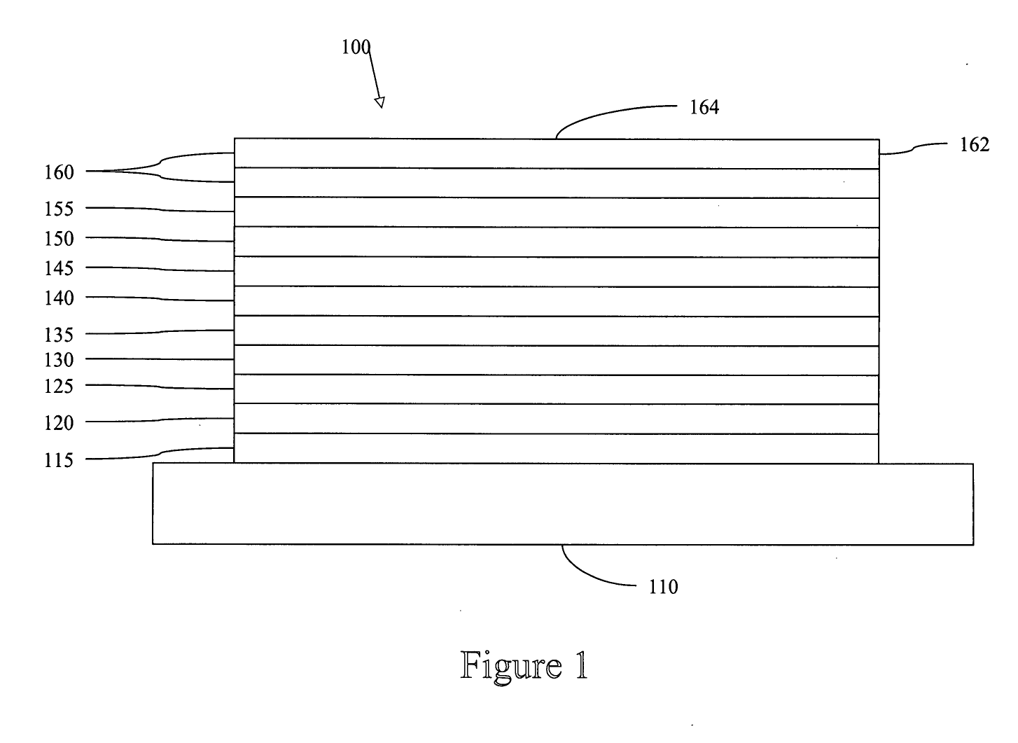

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, and a cathode 160. Cathode 160 is a compound cathode having a first conductive layer 162 and a second conductive layer 164. Device 100 may be fabricated by depositing the layers described, in order.

Substrate 110 may be any suitable substrate that provides desired structural properties. Substrate 110 may be flexible or rigid. Substrate 110 may be transparent, translucent or opaque. Plastic and glass are examples of preferred rigid substrate materials. Plastic and metal foils are examples of preferred flexible substrate materials. Substrate 110 may be a semiconductor material in order to facilitate the fabrication of circuitry. For example, substrate 110 may be a silicon wafer upon which circuits are fabricated, capable of controlling OLEDs subsequently deposited on the substrate. Other substrates may be used. The material and thickness of substrate 110 may be chosen to obtain desired structural and optical properties.

Anode 115 may be any suitable anode that is sufficiently conductive to transport holes to the organic layers. The material of anode 115 preferably has a work function higher than about 4 eV (a “high work function material”). Preferred anode materials include conductive metal oxides, such as indium tin oxide (ITO) and indium zinc oxide (IZO), aluminum zinc oxide (AlZnO), and metals. Anode 115 (and substrate 110) may be sufficiently transparent to create a bottom-emitting device. A preferred transparent substrate and anode combination is commercially available ITO (anode) deposited on glass or plastic (substrate). A flexible and transparent substrate-anode combination is disclosed in U.S. Pat. No. 5,844,363, which is incorporated by reference in its entirety. Anode 115 may be opaque and/or reflective. A reflective anode 115 may be preferred for some top-emitting devices, to increase the amount of light emitted from the top of the device. The material and thickness of anode 115 may be chosen to obtain desired conductive and optical properties. Where anode 115 is transparent, there may be a range of thickness for a particular material that is thick enough to provide the desired conductivity, yet thin enough to provide the desired degree of transparency. Other anode materials and structures may be used.

Hole transport layer 125 may include a material capable of transporting holes. Hole transport layer 130 may be intrinsic (undoped), or doped. Doping may be used to enhance conductivity. α-NPD and TPD are examples of intrinsic hole transport layers. An example of a p-doped hole transport layer is m-MTDATA doped with F₄-TCNQ at a molar ratio of 50:1, as disclosed in U.S. patent application Ser. No. 10/173,682 to Forrest et al., which is incorporated by reference in its entirety. Other hole transport layers may be used.

Emissive layer 135 may include an organic material capable of emitting light when a current is passed between anode 115 and cathode 160. Preferably, emissive layer 135 contains a phosphorescent emissive material, although fluorescent emissive materials may also be used. Phosphorescent materials are preferred because of the higher luminescent efficiencies associated with such materials. Emissive layer 135 may also comprise a host material capable of transporting electrons and/or holes, doped with an emissive material that may trap electrons, holes, and/or excitons, such that excitons relax from the emissive material via a photoemissive mechanism. Emissive layer 135 may comprise a single material that combines transport and emissive properties. Whether the emissive material is a dopant or a major constituent, emissive layer 135 may comprise other materials, such as dopants that tune the emission of the emissive material. Emissive layer 135 may include a plurality of emissive materials capable of, in combination, emitting a desired spectrum of light. Examples of phosphorescent emissive materials include Ir(ppy)₃. Examples of fluorescent emissive materials include DCM and DMQA. Examples of host materials include Alq₃, CBP and mCP. Examples of emissive and host materials are disclosed in U.S. Pat. No. 6,303,238 to Thompson et al., which is incorporated by reference in its entirety. Emissive material may be included in emissive layer 135 in a number of ways. For example, an emissive small molecule may be incorporated into a polymer. Other emissive layer materials and structures may be used.

Electron transport layer 140 may include a material capable of transporting electrons. Electron transport layer 140 may be intrinsic (undoped), or doped. Doping may be used to enhance conductivity. Alq₃ is an example of an intrinsic electron transport layer. An example of an n-doped electron transport layer is BPhen doped with Li at a molar ratio of 1:1, as disclosed in U.S. patent application Ser. No. 10/173,682 to Forrest et al., which is incorporated by reference in its entirety. Other electron transport layers may be used.

The charge carrying component of the electron transport layer may be selected such that electrons can be efficiently injected from the cathode into the LUMO (Lowest Unoccupied Molecular Orbital) level of the electron transport layer. The “charge carrying component” is the material responsible for the LUMO that actually transports electrons. This component may be the base material, or it may be a dopant. The LUMO level of an organic material may be generally characterized by the electron affinity of that material and the relative electron injection efficiently of a cathode may be generally characterized in terms of the work function of the cathode material. This means that the preferred properties of an electron transport layer and the adjacent cathode may be specified in terms of the electron affinity of the charge carrying component of the ETL and the work function of the cathode material. In particular, so as to achieve high electron injection efficiency, the work function of the cathode material is preferably not greater than the electron affinity of the charge carrying component of the electron transport layer by more than about 0.75 eV, more preferably, by not more than about 0.5 eV. Similar considerations apply to any layer into which electrons are being injected.

Cathode 160 may be any suitable material or combination of materials known to the art, such that cathode 160 is capable of conducting electrons and injecting them into the organic layers of device 100. Cathode 160 may be transparent or opaque, and may be reflective. Metals and metal oxides are examples of suitable cathode materials. Cathode 160 may be a single layer, or may have a compound structure. FIG. 1 shows a compound cathode 160 having a thin metal layer 162 and a thicker conductive metal oxide layer 164. In a compound cathode, preferred materials for the thicker layer 164 include ITO, IZO, and other materials known to the art. U.S. Pat. Nos. 5,703,436 and 5,707,745, which are incorporated by reference in their entireties, disclose examples of cathodes including compound cathodes having a thin layer of metal such as Mg:Ag with an overlying transparent, electrically-conductive, sputter-deposited ITO layer. The part of cathode 160 that is in contact with the underlying organic layer, whether it is a single layer cathode 160, the thin metal layer 162 of a compound cathode, or some other part, is preferably made of a material having a work function lower than about 4 eV (a “low work function material”). Other cathode materials and structures may be used.

Blocking layers may be used to reduce the number of charge carriers (electrons or holes) and/or excitons that leave the emissive layer. An electron blocking layer 130 may be disposed between emissive layer 135 and the hole transport layer 125, to block electrons from leaving emissive layer 135 in the direction of hole transport layer 125. Similarly, a hole blocking layer 140 may be disposed between emissive layer 135 and electron transport layer 145, to block holes from leaving emissive layer 135 in the direction of electron transport layer 140. Blocking layers may also be used to block excitons from diffusing out of the emissive layer. The theory and use of blocking layers is described in more detail in U.S. Pat. No. 6,097,147 and U.S. patent application Ser. No. 10/173,682 to Forrest et al., which are incorporated by reference in their entireties.

As used herein, the term “blocking layer” means that the layer provides a barrier that significantly inhibits transport of charge carriers and/or excitons through the device, without suggesting that the layer necessarily completely blocks the charge carriers and/or excitons. The presence of such a blocking layer in a device may result in substantially higher efficiencies as compared to a similar device lacking a blocking layer. Also, a blocking layer may be used to confine emission to a desired region of an OLED.

Generally, injection layers are comprised of a material that may improve the injection of charge carriers from one layer, such as an electrode or an organic layer, into an adjacent organic layer. Injection layers may also perform a charge transport function. In device 100, hole injection layer 120 may be any layer that improves the injection of holes from anode 115 into hole transport layer 125. CuPc is an example of a material that may be used as a hole injection layer from an ITO anode 115, and other anodes. In device 100, electron injection layer 150 may be any layer that improves the injection of electrons into electron transport layer 145. LiF/Al is an example of a material that may be used as an electron injection layer into an electron transport layer from an adjacent layer. Other materials or combinations of materials may be used for injection layers. Depending upon the configuration of a particular device, injection layers may be disposed at locations different than those shown in device 100. More examples of injection layers are provided in U.S. patent application Ser. No. 09/931,948 to Lu et al., which is incorporated by reference in its entirety. A hole injection layer may comprise a solution deposited material, such as a spin-coated polymer, e.g., PEDOT:PSS, or it may be a vapor deposited small molecule material, e.g., CuPc or MTDATA.

A hole injection layer (HIL) may planarize or wet the anode surface so as to provide efficient hole injection from the anode into the hole injecting material. A hole injection layer may also have a charge carrying component having HOMO (Highest Occupied Molecular Orbital) energy levels that favorably match up, as defined by their herein-described relative ionization potential (IP) energies, with the adjacent anode layer on one side of the HIL and the hole transporting layer on the opposite side of the HIL. The “charge carrying component” is the material responsible for the HOMO that actually transports holes. This component may be the base material of the HIL, or it may be a dopant. Using a doped HIL allows the dopant to be selected for its electrical properties, and the host to be selected for morphological properties such as wetting, flexibility, toughness, etc. Preferred properties for the HIL material are such that holes can be efficiently injected from the anode into the HIL material. In particular, the charge carrying component of the HIL preferably has an IP not more than about 0.7 eV greater that the IP of the anode material. More preferably, the charge carrying component has an IP not more than about 0.5 eV greater than the anode material. Similar considerations apply to any layer into which holes are being injected. HIL materials are further distinguished from conventional hole transporting materials that are typically used in the hole transporting layer of an OLED in that such HIL materials may have a hole conductivity that is substantially less than the hole conductivity of conventional hole transporting materials. The thickness of the HIL of the present invention may be thick enough to help planarize or wet the surface of the anode layer. For example, an HIL thickness of as little as 10 nm may be acceptable for a very smooth anode surface. However, since anode surfaces tend to be very rough, a thickness for the HIL of up to 50 nm may be desired in some cases.

A protective layer may be used to protect underlying layers during subsequent fabrication processes. For example, the processes used to fabricate metal or metal oxide top electrodes may damage organic layers, and a protective layer may be used to reduce or eliminate such damage. In device 100, protective layer 155 may reduce damage to underlying organic layers during the fabrication of cathode 160. Preferably, a protective layer has a high carrier mobility for the type of carrier that it transports (electrons in device 100), such that it does not significantly increase the operating voltage of device 100. CuPc, BCP, and various metal phthalocyanines are examples of materials that may be used in protective layers. Other materials or combinations of materials may be used. The thickness of protective layer 155 is preferably thick enough that there is little or no damage to underlying layers due to fabrication processes that occur after organic protective layer 160 is deposited, yet not so thick as to significantly increase the operating voltage of device 100. Protective layer 155 may be doped to increase its conductivity. For example, a CuPc or BCP protective layer 160 may be doped with Li. A more detailed description of protective layers may be found in U.S. patent application Ser. No. 09/931,948 to Lu et al., which is incorporated by reference in its entirety.

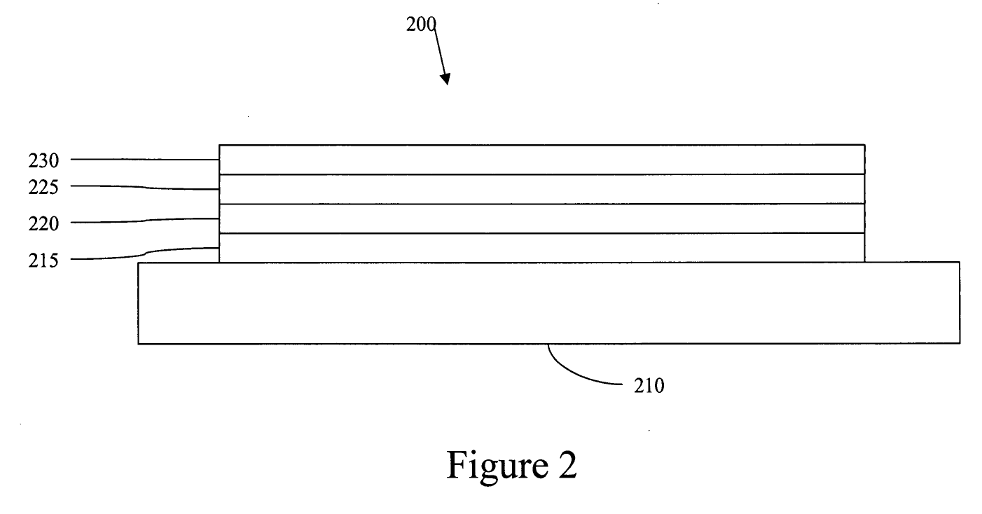

FIG. 2 shows an inverted OLED 200. The device includes a substrate 210, an cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190, Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. patent application Ser. No. 10/233,470, which is incorporated by reference in its entirety. Other suitable deposition methods include spin coating and other solution based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink-jet and OVJD. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processibility than those having symmetric structures, because asymmetric materials may have a lower tendency to recrystallize. Dendrimer substituents may be used to enhance the ability of small molecules to undergo solution processing.

Devices fabricated in accordance with embodiments of the invention may be incorporated into a wide variety of consumer products, including flat panel displays, computer monitors, televisions, billboards, lights for interior or exterior illumination and/or signaling, heads up displays, fully transparent displays, flexible displays, laser printers, telephones, cell phones, personal digital assistants (PDAs), laptop computers, digital cameras, camcorders, viewfinders, micro-displays, vehicles, a large area wall, theater or stadium screen, or a sign. Various control mechanisms may be used to control devices fabricated in accordance with the present invention, including passive matrix and active matrix. Many of the devices are intended for use in a temperature range comfortable to humans, such as 18 degrees C. to 30 degrees C., and more preferably at room temperature (20-25 degrees C.).

The materials and structures described herein may have applications in devices other than OLEDs. For example, other optoelectronic devices such as organic solar cells and organic photodetectors may employ the materials and structures. More generally, organic devices, such as organic transistors, may employ the materials and structures.

The term “halo” or “halogen” as used herein includes fluorine, chlorine, bromine and iodine.

The term “alkyl” as used herein contemplates both straight and branched chain alkyl radicals. Preferred alkyl groups are those containing from one to fifteen carbon atoms and includes methyl, ethyl, propyl, isopropyl, butyl, isobutyl, tert-butyl, and the like. Additionally, the alkyl group may be optionally substituted with one or more substituents selected from halo, CN, CO₂R, C(O)R, NR₂, cyclic-amino, NO₂, and OR.

The term “cycloalkyl” as used herein contemplates cyclic alkyl radicals. Preferred cycloalkyl groups are those containing 3 to 7 carbon atoms and includes cyclopropyl, cyclopentyl, cyclohexyl, and the like. Additionally, the cycloalkyl group may be optionally substituted with one or more substituents selected from halo, CN, CO₂R, C(O)R, NR₂, cyclic-amino, NO₂, and OR.

The term “alkenyl” as used herein contemplates both straight and branched chain alkene radicals. Preferred alkenyl groups are those containing two to fifteen carbon atoms. Additionally, the alkenyl group may be optionally substituted with one or more substituents selected from halo, CN, CO₂R, C(O)R, NR₂, cyclic-amino, NO₂, and OR.

The term “alkynyl” as used herein contemplates both straight and branched chain alkyne radicals. Preferred alkyl groups are those containing two to fifteen carbon atoms. Additionally, the alkynyl group may be optionally substituted with one or more substituents selected from halo, CN, CO₂R, C(O)R, NR₂, cyclic-amino, NO₂, and OR.

The terms “alkylaryl” as used herein contemplates an alkyl group that has as a substituent an aromatic group. Additionally, the alkylaryl group may be optionally substituted on the aryl with one or more substituents selected from halo, CN, CO₂R, C(O)R, NR₂, cyclic-amino, NO₂, and OR.

The term “heterocyclic group” as used herein contemplates non-aromatic cyclic radicals. Preferred heterocyclic groups are those containing 3 or 7 ring atoms which includes at least one hetero atom, and includes cyclic amines such as morpholino, piperdino, pyrrolidino, and the like, and cyclic ethers, such as tetrahydrofuran, tetrahydropyran, and the like.

The term “aryl” or “aromatic group” as used herein contemplates single-ring groups and polycyclic ring systems. The polycyclic rings may have two or more rings in which two carbons are common by two adjoining rings (the rings are “fused”) wherein at least one of the rings is aromatic, e.g., the other rings can be cycloalkyls, cycloalkenyls, aryl, heterocycles and/or heteroaryls.

The term “heteroaryl” as used herein contemplates single-ring hetero-aromatic groups that may include from one to three heteroatoms, for example, pyrrole, furan, thiophene, imidazole, oxazole, thiazole, triazole, pyrazole, pyridine, pyrazine and pyrimidine, and the like. The term heteroaryl also includes polycyclic hetero-aromatic systems having two or more rings in which two atoms are common to two adjoining rings (the rings are “fused”) wherein at least one of the rings is a heteroaryl, e.g., the other rings can be cycloalkyls, cycloalkenyls, aryl, heterocycles and/or heteroaryls.

The phosphorescent compounds of the present invention comprise two metal centers, wherein at least one metal is bound to at least one photoactive ligand. This ligand is referred to as a “photoactive” ligand because it is believed to directly contribute to the photoactive properties of the emissive material. Whether a ligand is photoactive depends upon the specific compound in which the ligand is present. For example, each of the ppy ligands of Ir(ppy)₃ is considered photoactive. However, in the compound (ppy)₂IrX, having two ppy ligands coordinated to the Ir, as well as an X ligand coordinated to the Ir, the ppy ligands may not be photoactive, particularly if the X ligand has a lower triplet energy than the ppy ligands. Other examples of photoactive ligands are disclosed in U.S. patent application Ser. No. 10/289,915 to Brown et al, which is incorporated by reference in its entirety. Each metal center may also be bound to a bridging ligand, a polymer, or a small molecule that is bound to both of the metal centers.

Each metal may be any metal having an atomic weight greater than 40. Preferred metals include Ir, Pt, Pd, Rh, Re, Os, Ti, Pb, Bi, In, Sn, Sb, Te, Au, and Ag. More preferably, the metal is Ir or Pt. Most preferably, the metal is Pt.

In an embodiment of the present invention, a bridging ligand is coordinated to both metal centers, and at least one photoactive ligand is bound to each metal. In this embodiment, the transition dipole moment of the first photoactive ligand is orthogonal to the transition dipole moment of the second photoactive ligand.

The term “orthogonal” as used herein refers to a relative orientation that contemplates minimal overlap of π orbitals such that there is no substantial energy transfer between metal complexes. Molecular orbital calculations are the best way to determine whether the transition dipole moments are orthogonal. It is believed that, for many molecules, if the planes of the transition dipole moments form an angle between about 80 degrees and 100 degrees, the transition dipole moments may be considered orthogonal.

The transition dipole moment (Mₙₘ) refers to the dipole moment of a molecule polarized by an electric field. Notably, the transition dipole moment, unlike the dipole moment of a molecule in the ground state, is not measured empirically. Rather, it is calculated using an equation. An oscillating electric or magnetic moment can be induced in an atom or molecular entity by an electromagnetic wave. Its interaction with the electromagnetic field is resonant if the frequency of the latter corresponds to the energy difference between the initial and final states of a transition (ΔE=hν). The amplitude of this moment is referred to as the transition moment. It can be calculated from an integral taken over the product of the wavefunctions of the initial (m) and final (n) states of a spectral transition and the appropriate dipole moment operator of the electromagnetic radiation. Its sign is arbitrary, its direction in the molecular framework defines the direction of transition polarization, and its square determines the strength of the transition. The SI unit of the transition dipole moment is C·m. The common unit is debye (D).

In a most preferred embodiment, there is no measurable energy transfer rate between the metal centers. This allows each phosphorescent metal center to independently emit light. The emission from each metal center may be further tuned independently to prepare a white OLED.

When the transition dipole moments of each metal center in a dyad are not orthogonal, energy transfer is likely to occur from the ligand and metal center with higher triplet energy to the ligand and metal center with lower triplet energy, such that the higher triplet energy ligand never or only very rarely emits light, and would not be considered photoactive. Conversely, when the transition dipole moments are orthogonal, such energy transfer will rarely occur, and the ligands coordinated with both metal centers may both emit light, even though one ligand has a higher triplet energy than the other. As a result, a composite spectrum may be obtained using a single molecule. If the concentration of such molecules is too high, however, there may be energy transfer between the ligand having a higher triplet energy of one molecule to a ligand having a lower triplet energy of another molecule. Figure _shows that at high concentrations, intermolecular energy transfer between two dyads (presumably through excimer formation) can occur, leading to weak emission from the high energy site. However, employing lower concentrations of the emissive materials is believed to moderate the rate of energy transfer.

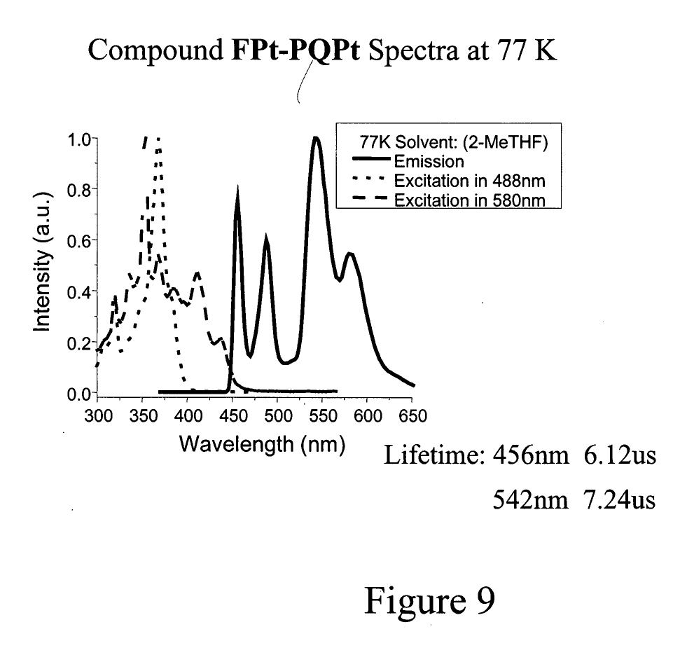

In one embodiment, at least one photoactive ligand has a triplet energy corresponding to a wavelength less than 480 nm. In another embodiment, at least one photoactive ligand has a triplet energy corresponding to a wavelength of 550-600 nm. Most preferably, at least one photoactive ligand attached to the first metal has a triplet energy corresponding to a wavelength of 480 nm and another photoactive ligand attached to the second metal has a triplet energy corresponding to a wavelength of 550-600 nm. It is believed that this embodiment is conducive to the preparation of a white OLED. A specific example of this embodiment is illustrated in FIG. 9, which shows the emission spectra at 77 K for synthesized complex FPt-PQPt. FPt-PQPt is shown to exhibit dual emission at peak wavelengths of 456 nm and 542 nm. In another embodiment, at least one photoactive ligand attached to the first metal has a triplet energy corresponding to a wavelength of 500-520 nm. In another embodiment, at least one photoactive ligand attached to the first metal has a triplet energy corresponding to a wavelength of 590 nm.

One method of designing for a zero energy transfer between the metal centers is by selecting an appropriate bridging ligand. The most preferred bridging ligand in the present invention is diacetylacetonate (diacac), which has the following structure:

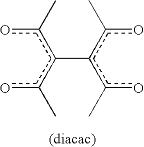

An embodiment wherein both metals are Pt may have the following structure: 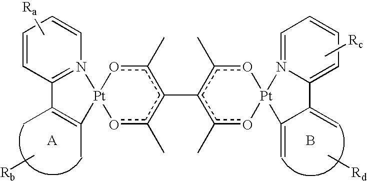
wherein ring A and ring B are each independently an aromatic heterocyclic or fused aromatic heterocyclic ring; each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group; additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R. In this embodiment, the diacac forces the transition dipole moment of each metal center to lie in the Pt square plane, each of which is orthogonal to the other. Because Pt is square planar, an embodiment where both metal centers are Pt and the bridging ligand is diacac may be particularly preferred, because the transition dipole moment associated with the two different metal centers will generally be orthogonal, unless there is excessive twisting caused by ligands coordinated to the metal centers. Although at room temperature there is a slight twisting about the C—C acac-acac bond, and energy transfer has been observed, at low temperature and in the solid state energy transfer was not observed while a simultaneous blue and orange emission was observed for embodiments with the following structures:

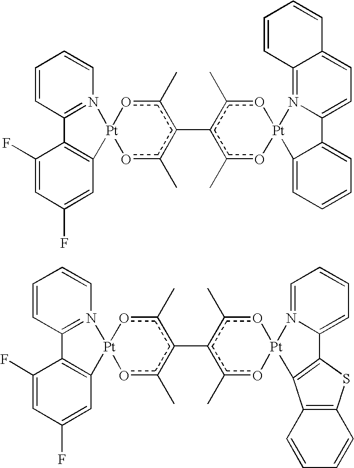

Other embodiments of this invention includes compounds with the following structures:

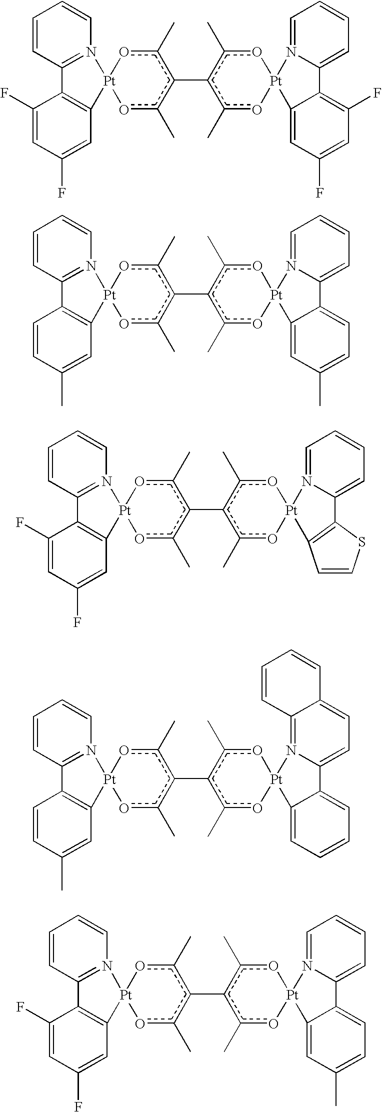

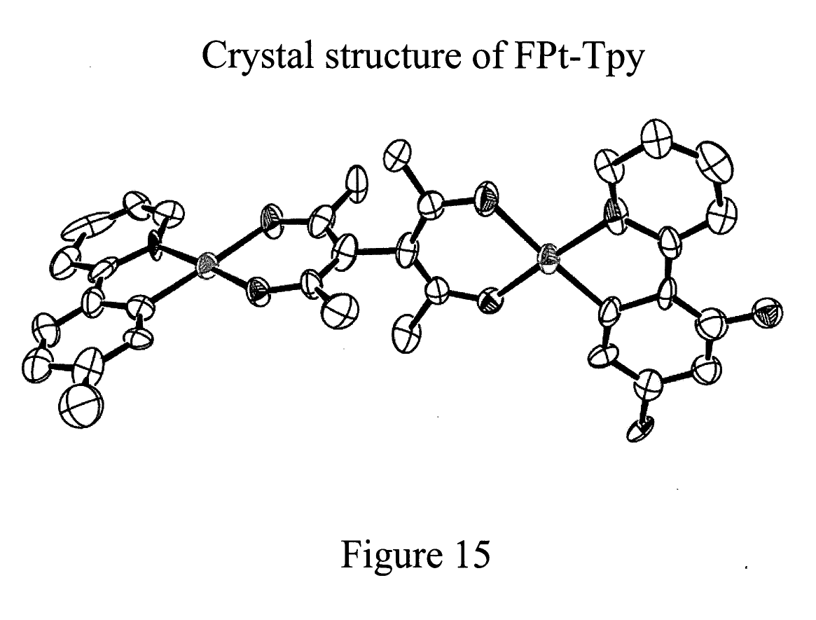

A bridging ligand of the present invention preferably (a) coordinates the two metal centers and (b) forces an orthogonal relationship between the two metal coordination planes. The diacac ligand illustrated above accomplishes this by coordinating the two metals through metal-acac bonding. The orthogonal relationship is forced by steric interactions between the methyl groups of the two acac ligands. This may be observed in the crystal structure of FPt-Tpy, where the angle between the Pt-acac planes was found to be 89° (structure determined by single crystal X-ray diffraction), as shown in FIG. 15. Other preferred bridging ligands of this invention include ligands where the key components are retained, i.e. the metals are coordinated by strong chelating ligands and the metal-ligand planes are held orthogonal. Preferred bridging ligands include:

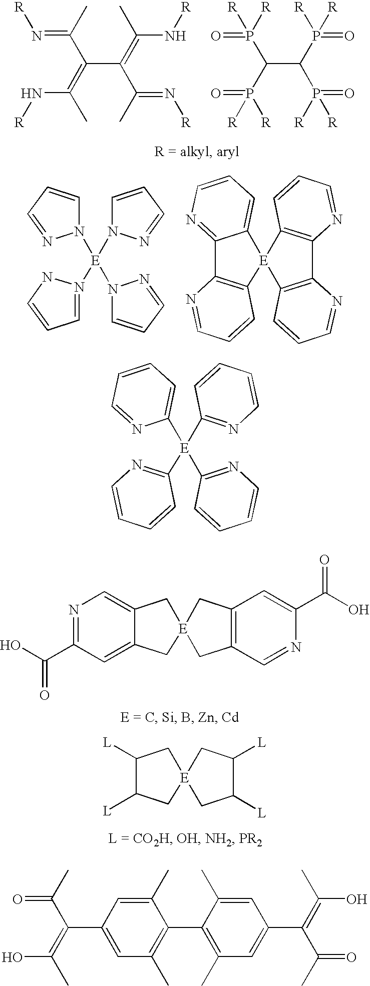

In one embodiment, the first metal center and the atoms of the bridging ligand that are coordinated to the first metal center define a first plane, and the second metal center and the atoms of the bridging ligand that are coordinated to the second metal center define a second plane, and the first and second plane form an angle that is between about 80 degrees and 100 degrees. Preferably, the bridging ligand is diacac. In another preferred embodiment, at least one metal is Pt.

In another embodiment, the first metal and the second metal are the same metal. Preferred metals of this embodiment include Pt and Ir. In an embodiment in which both metal centers are Ir, metal complexes and the bridging ligand is diacac, the transition dipole moment lies outside the Ir(acac) plane. Consequently, energy transfer is allowed between the two metal centers. Complete intramolecular energy transfer has been observed in some cases. An embodiment of this invention include compounds with the following structure: 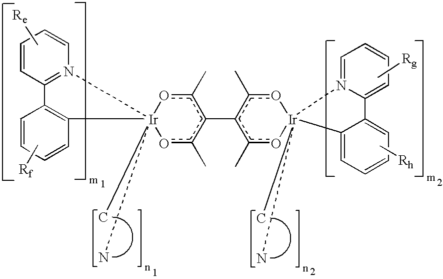
wherein (C—N) is a substituted or unsubstituted cyclometallated non-emissive ligand;
m has a value of 1 or 2;
(m₁+n₁) is 2; (m₂+n₂) is 2;
each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group;
   additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R.

All value ranges, for example those given for n and m, are inclusive over the entire range. Thus, for example, a range between 0-4 would include the values 0, 1, 2, 3 and 4.

(C—N) represents a photoactive ligand.
n represents the number of ligands of a particular type, which do not emit at room temperature. n has a value of at least 1. m represents the number of photoactive ligands of a particular type, and has a value of at least 1. The maximum number of ligands that may be attached to the metal is m+n.

In a preferred embodiment, m is 2 and n is zero. In another embodiment, m₁ and m₂ are each 2 and n₁ and n₂ are zero. An embodiment of this invention includes a compound with the following structure:

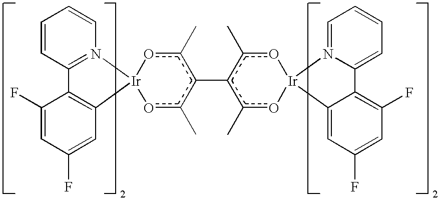

In other embodiments, a polymer or small molecule is coordinated to both metal center, and the metal-ligand complex of the first metal center is different from the metal-ligand complex of the second metal center. In one embodiment, the first metal is different from the second metal. This embodiment may have the following structure:

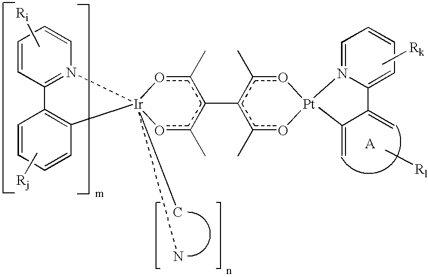

Other preferred embodiments include compounds with the following structures:

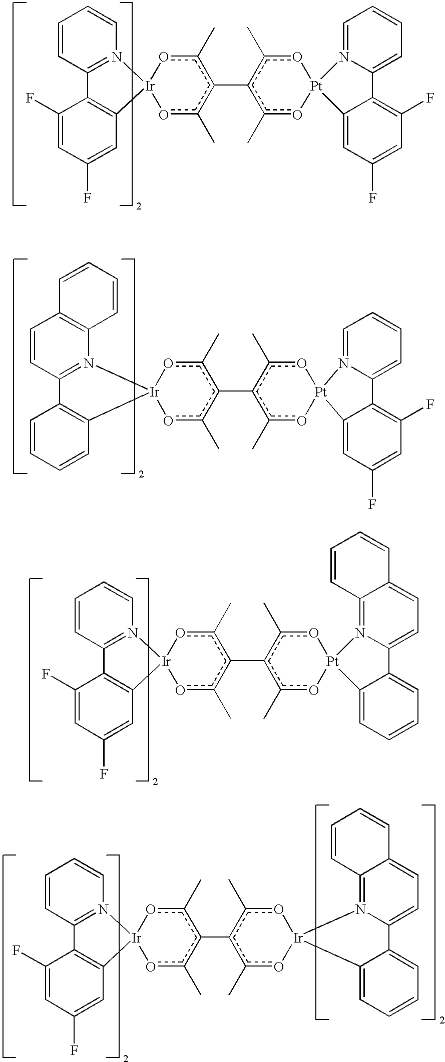

It is understood that the various embodiments described herein are by way of example only, and are not intended to limit the scope of the invention. For example, many of the materials and structures described herein may be substituted with other materials and structures without deviating from the spirit of the invention. It is understood that various theories as to why the invention works are not intended to be limiting. For example, theories relating to charge transfer are not intended to be limiting.

Material Definitions:

As used herein, abbreviations refer to materials as follows:
CBP: 4,4′-N,N-dicarbazole-biphenyl
m-MTDATA 4,4′,4″-tris(3-methylphenylphenlyamino)triphenylamine
Alq₃: 8-tris-hydroxyquinoline aluminum
Bphen: 4,7-diphenyl-1,10-phenanthroline
n-BPhen: n-doped BPhen (doped with lithium)
F₄-TCNQ: tetrafluoro-tetracyano-quinodimethane
p-MTDATA: p-doped m-MTDATA (doped with F₄-TCNQ)
Ir(ppy)₃: tris(2-phenylpyridine)-iridium
Ir(ppz)₃: tris(1-phenylpyrazoloto,N,C(2′)iridium(III)
BCP: 2,9-dimethyl-4,7-diphenyl-1,10-phenanthroline
TAZ: 3-phenyl-4-(1′-naphthyl)-5-phenyl-1,2,4-triazole
CuPc: copper phthalocyanine.
ITO: indium tin oxide
NPD: N,N′-diphenyl-N—N′-di(1-naphthyl)-benzidine
TPD: N,N′-diphenyl-N—N′-di(3-toly)-benzidine
BAlq: aluminum(M)bis(2-methyl-8-hydroxyquinolinato)₄-phenylphenolate
mCP: 1,3-N,N-dicarbazole-benzene
DCM: 4-(dicyanoethylene)-6-(4-dimethylaminostyryl-2-methyl)-4H-pyran
DMQA: N,N′-dimethylquinacridone
PEDOT:PSS: an aqueous dispersion of poly(3,4-ethylenedioxythiophene) with polystyrenesulfonate (PSS)
DiFPt: BisPlatinum(II) (2-(4′,6′-difluorophenyl)pyridinato-N,C^{2′}) (2,4-pentanedionato-O,O).
FPt-Thpy: (2-(4′,6′-difluorophenyl)pyridinato-N,C^{2′}) Platinum(II)(1,1,2,2,-tetraacetylethane)platinum(II) (2-(2′-thienyl)pyridinato-N,C^{2′})
FPt-PQPt: (2-(4′,6′-difluorophenyl)pyridinato-N,C^{2′}) Platinum(II)(1,1,2,2,-tetraacetylethane)platinum (II) (2-phenylquinolyl-N,C^{2′})
FPt-Btp: (2-(4′,6′-difluorophenyl)pyridinato-N,C^{2′}) Platinum(II)(1,1,2,2,-tetraacetylethane)platinum(II)(2-2′-(4′,5′-benzo)thienyl)pyridinato-N,C^{3′})
FPt-PQIr: (2-(4′,6′-difluorophenyl)pyridinato-N,C^{2′}) Platinum(II)(1,1,2,2,-tetraacetylethane)Iridium(III)Bis(2-phenylquinolyl-N,C^{2′})
FIr-PQIr: Bis(2-(4′,6′-difluorophenyl)pyridinato-N,C^{2′})Iridium(III)(1,1,2,2,-tetraacetylethane)Iridium(III) Bis(2-phenylquinolyl-N,C^{2′})
FIr-PQPt: Bis(2-(4′,6′-difluorophenyl)pyridinato-N,C^{2′})Iridium(III)(1,1,2,2,-tetraacetylethane)platinum (II) (2-phenylquinolyl-N,C^{2′})
DiTpy: BisPlatinum(II) (2-(p-tolyl)pyridinato-N,C^{2′}) (2,4-pentanedionato-O,O).
FPt-Tpy: (2-(4′,6′-difluorophenyl)pyridinato-N,C^{2′}) Platinum(II)(1,1,2,2,-tetraacetylethane) Platinum(II) (2-(p-tolyl)pyridinato-N,C^{2′})

### EXPERIMENTAL

Specific representative embodiments of the invention will now be described, including how such embodiments may be made. It is understood that the specific methods, materials, conditions, process parameters, apparatus and the like do not necessarily limit the scope of the invention.

### Example 1

### General Synthetic Scheme for a Cyclometallated Pt(Diacac)

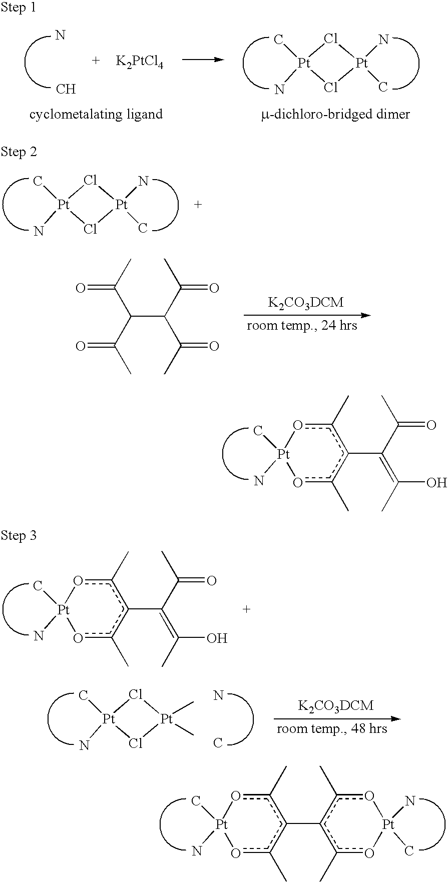

Synthesis of iridium complexes is similar to the above schematic with Ir being substituted for Pt.

### Example 2

Table I summarizes the Elemental Carbon, Hydrogen, Nitrogen Combustion Analysis (CHN).

TABLE I

| | | | | | CHN | | |
|---|---|---|---|---|---|---|---|
| Compound | Structure | CHN Theory | | | Experimental | | |
| DiFPt | 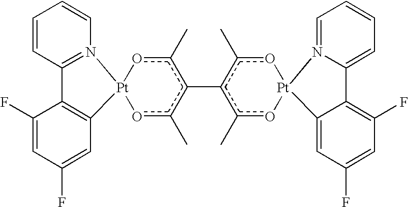 | 39.76 | 2.50 | 2.90 | 39.44 | 2.54 | 2.75 |
| Fpt-Thpy | 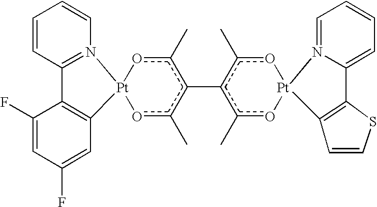 | 38.47 | 2.58 | 2.99 | 37.91 | 2.48 | 2.80 |
| FPt-PQPt | 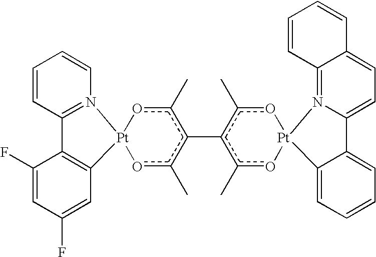 | 44.09 | 2.88 | 2.86 | 43.23 | 2.77 | 2.86 |
| FPt-Btp | 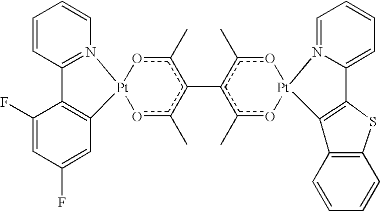 | 41.38 | 2.66 | 2.84 | 41.39 | 2.69 | 2.70 |
| FPt-PQIr | 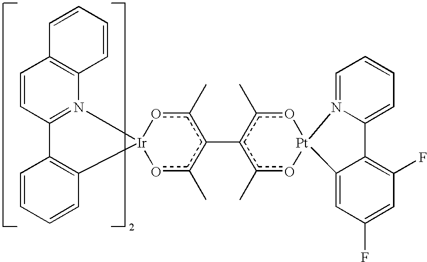 | 51.82 | 3.24 | 3.55 | 51.34 | 3.20 | 3.51 |
| FIr-PQIr | 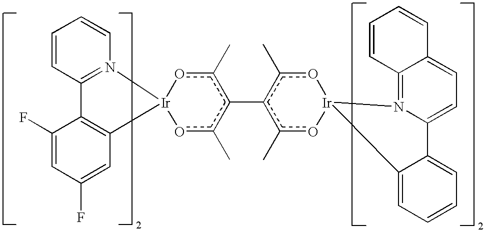 | 54.38 | 3.24 | 4.09 | 54.78 | 3.29 | 3.98 |
| FIr-PQPt | 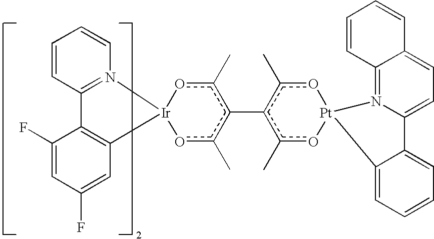 | 48.33 | 2.93 | 3.60 | 49.03 | 3.19 | 3.49 |

### Example 3

The color rendering index for FPt-PqPt is 62 and its CIE coordinates are 0.38, 0.38, based on the photoluminescence spectra.

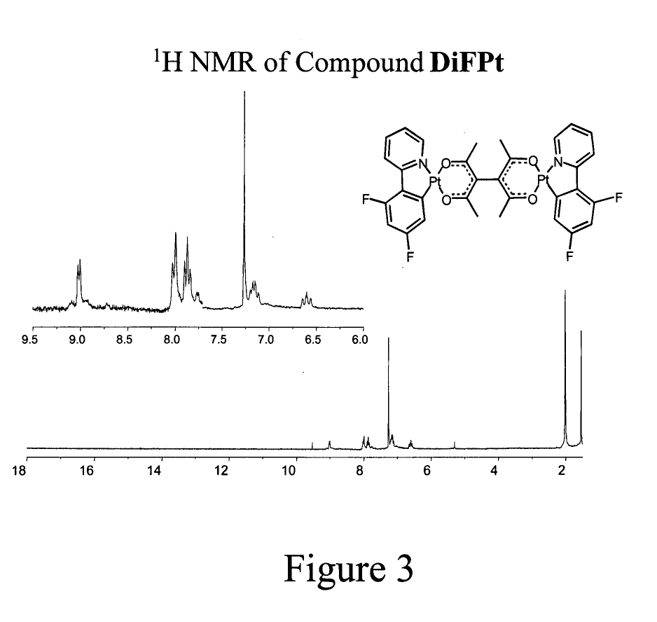

FIG. 3 shows the ¹H NMR spectra for DiFPt.

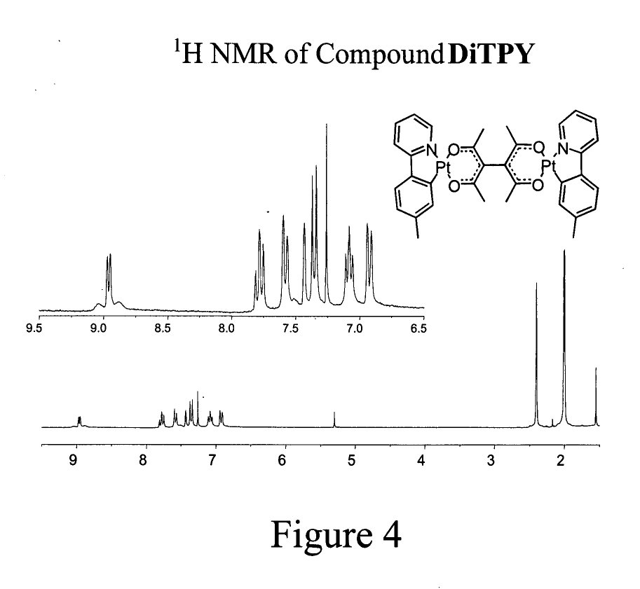

FIG. 4 shows the ¹H NMR spectra for DiTpy.

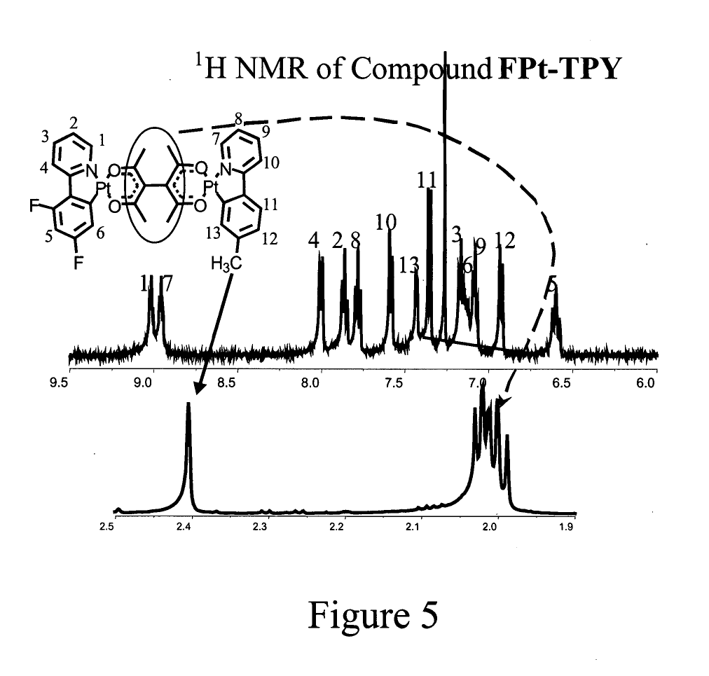

FIG. 5 shows the ¹H NMR spectra for FPt-Tpy.

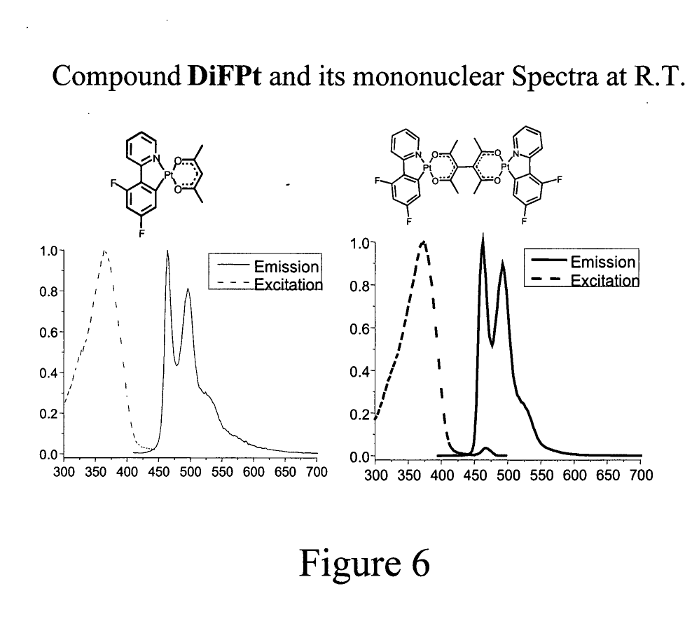

FIG. 6 shows the emission spectra at room temperature for DiFPt and its mononuclear component.

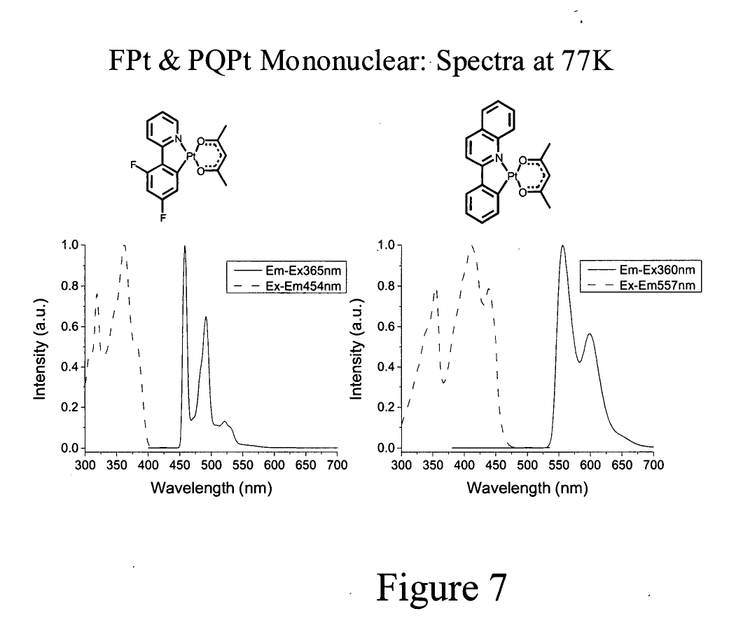

FIG. 7 shows the emission spectra at 77 K for FPt and PQPt and its mononuclear component.

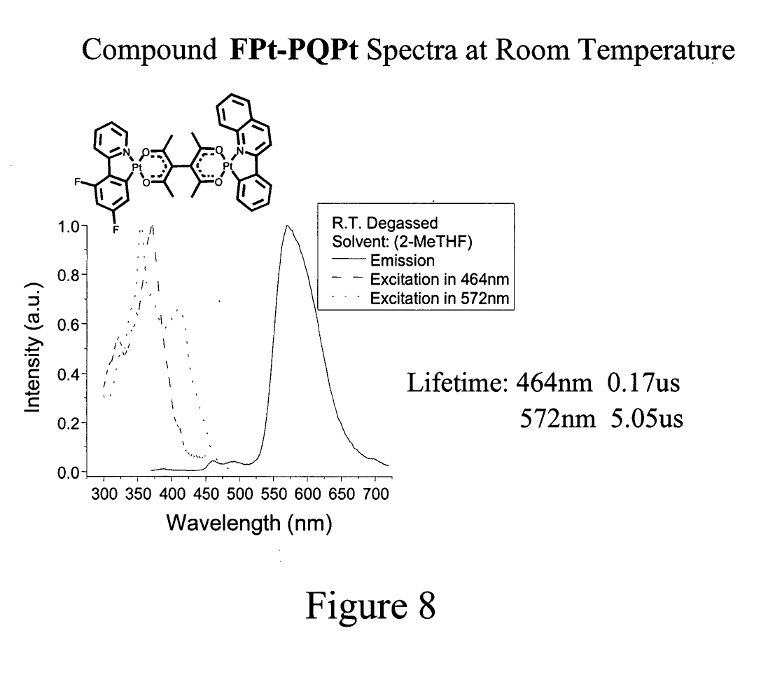

FIG. 8 shows the emission spectra at room temperature for FPt-PQPt. FPt-PQPt exhibits dual emission at peak wavelengths of 464 nm (0.17 μs lifetime) and 572 nm (5.05 μs lifetime).

FIG. 9 shows the emission spectra at 77 K for FPt-PQPt. FPt-PQPt exhibits dual emission at peak wavelengths of 456 nm (6.12 μs lifetime) and 542 nm (7.24 μs lifetime).

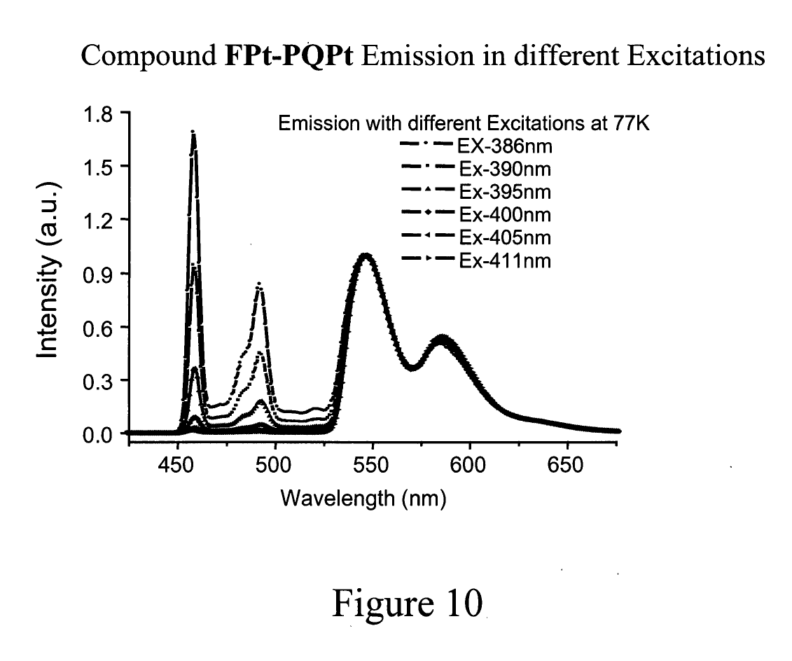

FIG. 10 shows the emission spectra for FPt-PQPt at different excitations at 77K.

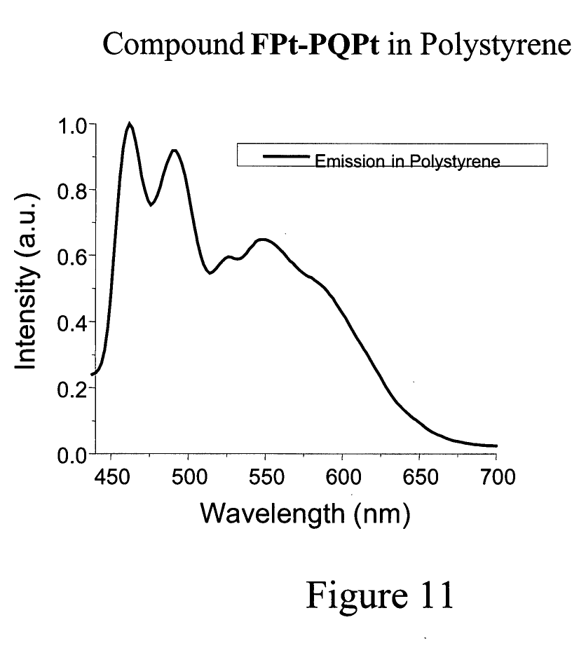

FIG. 11 shows the emission spectra for FPt-PQPt in polystyrene at room temperature.

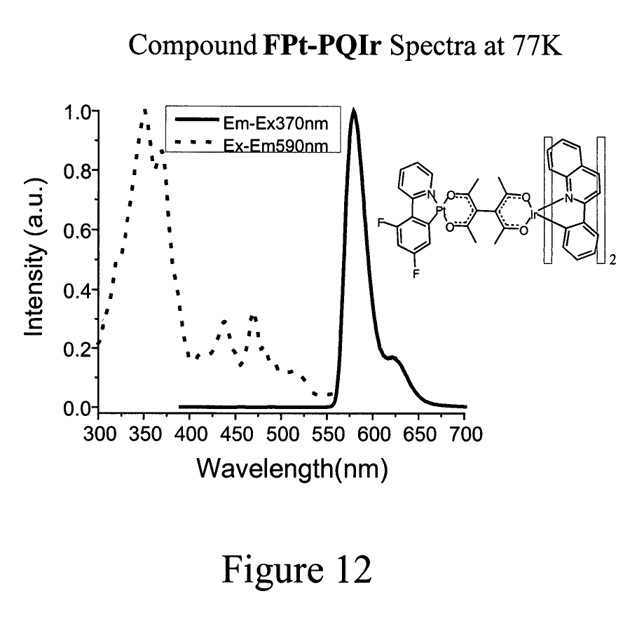

FIG. 12 shows the emission spectra at 77 K for FPt-PQIr.

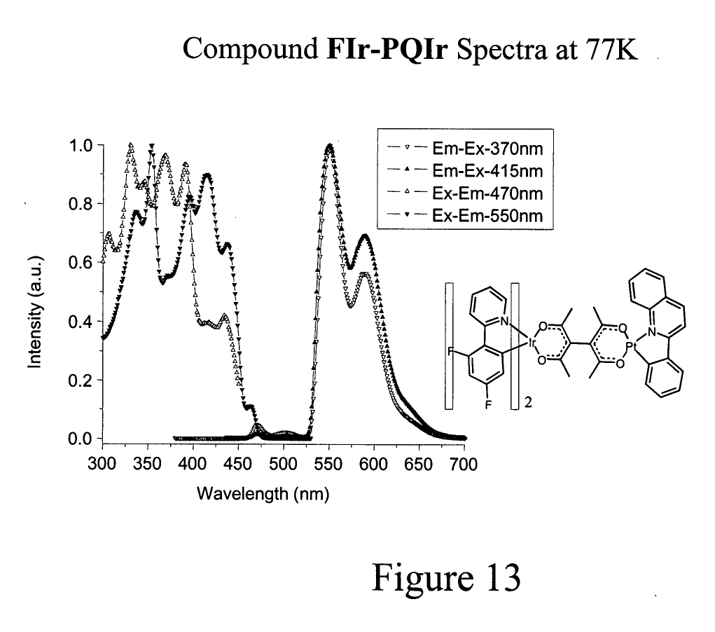

FIG. 13 shows the emission spectra at 77 K for FIr-PQIr.

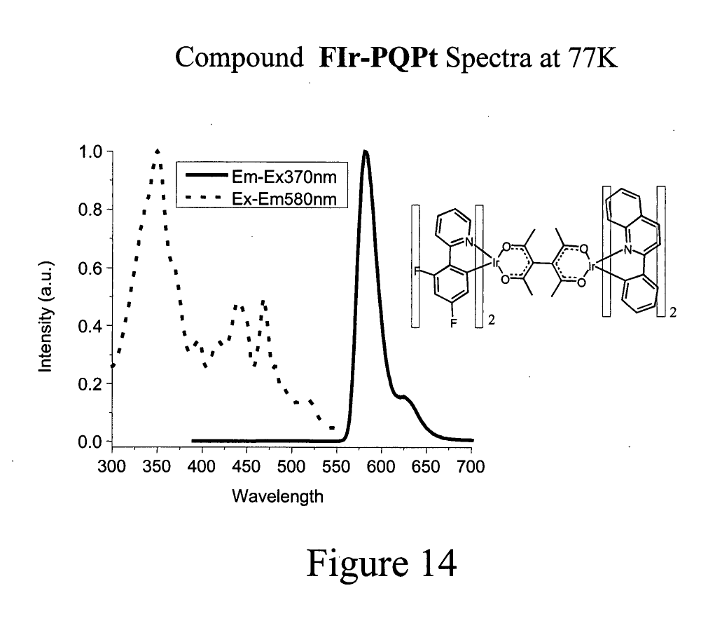

FIG. 14 shows the emission spectra at 77 K for FIr-PQPt.

FIG. 15 shows the crystal structure of FPt-Tpy.

While the present invention is described with respect to particular examples and preferred embodiments, it is understood that the present invention is not limited to these examples and embodiments. The present invention as claimed therefore includes variations from the particular examples and preferred embodiments described herein, as will be apparent to one of skill in the art.

1. A compound, comprising:
a first metal center and a second metal center, wherein each metal has an atomic weight greater than 40; and
a bridging ligand coordinated to the first metal center and the second metal center; and
at least one photoactive ligand bound to the first metal center, and at least one photoactive ligand bound to the second metal center; and
wherein the transition dipole moment of the first photoactive ligand is orthogonal to the transition dipole moment of the second photoactive ligand.

2. The compound of claim 1, wherein at least one photoactive ligand has a triplet energy corresponding to a wavelength less than 480 nm.

3. The compound of claim 1, wherein at least one photoactive ligand has a triplet energy corresponding to a wavelength of 550-600 nm.

4. The compound of claim 3, wherein at least one photoactive ligand has a triplet energy corresponding to a wavelength less than 480 nm.

5. The compound of claim 1, wherein at least one photoactive ligand has a triplet energy corresponding to a wavelength of 500-520 nm.

6. The compound of claim 1, wherein at least one photoactive ligand has a triplet energy corresponding to a wavelength greater than 590 nm.

7. The compound of claim 1, wherein the first metal is Pt.

8. The compound of claim 7, wherein the second metal is Pt.

9. The compound of claim 8, wherein the bridging ligand comprises the structure:

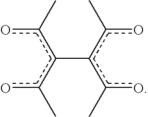

10. The compound of claim 9, having the structure: 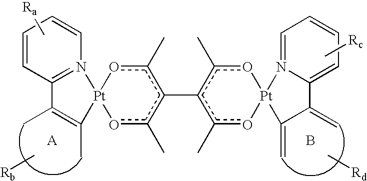
wherein
ring A and ring B are each independently an aromatic heterocyclic or fused aromatic heterocyclic ring;
each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group;
additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R.

11. The compound of claim 10, having the structure:

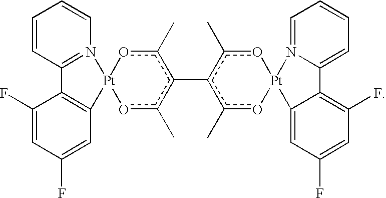

12. The compound of claim 10, having the structure:

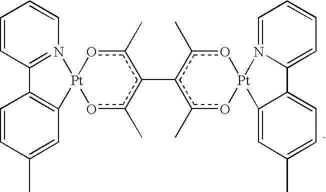

13. The compound of claim 10, having the structure:

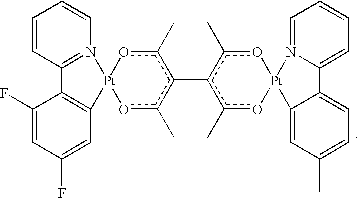

14. The compound of claim 10, having the structure:

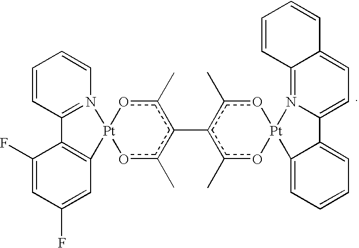

15. The compound of claim 10, having the structure:

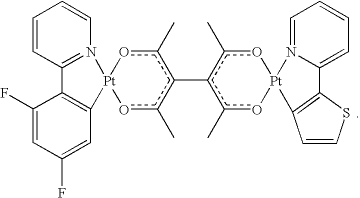

16. The compound of claim 10, having the structure:

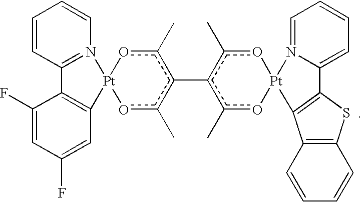

17. The compound of claim 10, having the structure:

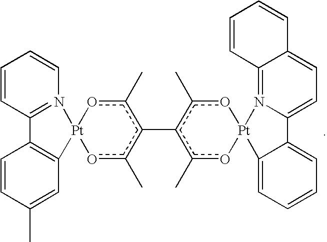

18. A compound, comprising:
a first metal center and a second metal center, wherein each metal has an atomic weight greater than 40;
a bridging ligand coordinated to the first metal center and the second metal; and
at least one photoactive ligand bound to the first metal center, and at least one photoactive ligand bound to the second metal center; and
wherein the first metal center and the atoms of the bridging ligand that are coordinated to the first metal center define a first plane, and the second metal center and the atoms of the bridging ligand that are coordinated to the second metal center define a second plane, and wherein the first plane and the second plane form an angle that is between about 80 degrees and 100 degrees.

19. The compound of claim 18, wherein at least one photoactive ligand has a triplet energy corresponding to a wavelength less than 480 nm.

20. The compound of claim 18, wherein at least one photoactive ligand has a triplet energy corresponding to a wavelength of 550-600 nm.

21. The compound of claim 20, wherein at least one photoactive ligand has a triplet energy corresponding to a wavelength less than 480 nm.

22. The compound of claim 18, wherein at least one photoactive ligand has a triplet energy corresponding to a wavelength of 500-520 nm.

23. The compound of claim 18, wherein at least one photoactive ligand has a triplet energy corresponding to a wavelength greater than 590 nm.

24. The compound of claim 18, wherein the bridging ligand comprises the structure:

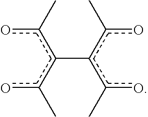

25. The compound of claim 24, wherein the first metal is Pt.

26. A compound, comprising:
a first metal center and a second metal center, wherein each metal has an atomic weight greater than 40;
a bridging ligand coordinated to the first metal center and the second metal center further comprising the structure 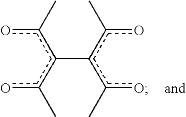
at least one photoactive ligand bound to the first metal center, and at least one photoactive ligand bound to the second metal center.

27. The compound of claim 26, wherein the first metal and the second metal are the same metal.

28. The compound of claim 27, wherein the first metal is Ir.

29. The compound of claim 28, having the structure: 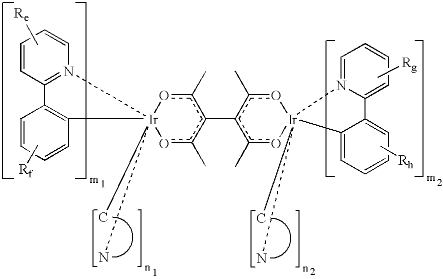
wherein
(C—N) is a substituted or unsubstituted cyclometallated non-emissive ligand;
m has a value of 1 or 2;
(m₁+n₁) is 2; (m₂+n₂) is 2;
each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group;
additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R.

30. The compound of claim 29, wherein m₁ is 2 and n₁ is zero.

31. The compound of claim 30, wherein m₂ is 2 and n₂ zero.

32. The compound of claim 31, having the structure:

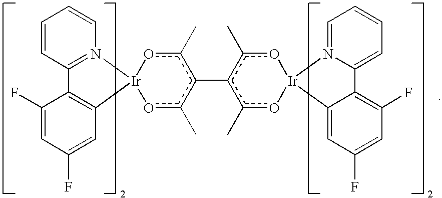

33. A compound, comprising
a first metal center and a second metal center, wherein each metal has an atomic weight greater than 40;
a polymer or small molecule coordinated to the first metal center and the second metal; and
at least one photoactive ligand bound to the first metal center, and at least one photoactive ligand bound to the second metal center, wherein the first metal-ligand complex is different from the second metal-ligand complex.

34. The compound of claim 33, wherein the first metal is Pt.

35. The compound of claim 33, wherein the first metal is Ir.

36. The compound of claim 33, wherein at least one photoactive ligand has a triplet energy corresponding to a wavelength less than 480 nm.

37. The compound of claim 33, wherein at least one photoactive ligand has a triplet energy corresponding to a wavelength of 550-600 nm.

38. The compound of claim 37, wherein at least one photoactive ligand has a triplet energy corresponding to a wavelength less than 480 nm.

39. The compound of claim 33, wherein at least one photoactive ligand has a triplet energy corresponding to a wavelength of 500-520 nm.

40. The compound of claim 33, wherein at least one photoactive ligand has a triplet energy corresponding to a wavelength greater than 590 nm.

41. The compound of claim 33, wherein the polymer or small molecule comprises the structure:

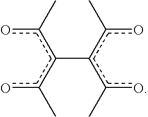

42. The compound of claim 41, wherein the first metal is Pt.

43. The compound of claim 42, wherein the second metal is Ir.

44. The compound of claim 43, having the structure: 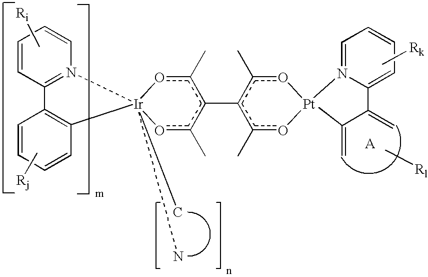
wherein
(C—N) is a substituted or unsubstituted cyclometallated non-emissive ligand;
m is a value from 1 to 3;
m+n is 3;
ring A is an aromatic heterocyclic or fused aromatic heterocyclic ring;
each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group;
additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R.

45. The compound of claim 44, wherein m is 2 and n is zero.

46. The compound of claim 45, having the structure:

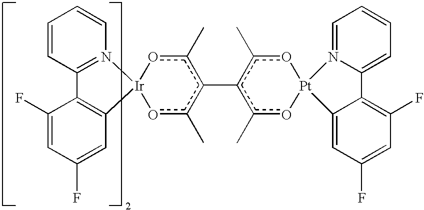

47. The compound of claim 45, having the structure:

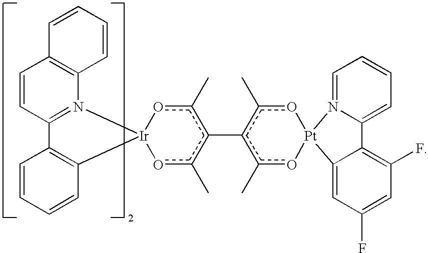

48. The compound of claim 45, having the structure:

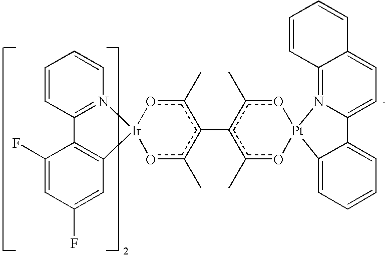

49. The compound of claim 41, wherein the first metal is Ir.

50. The compound of claim 49, having the structure: 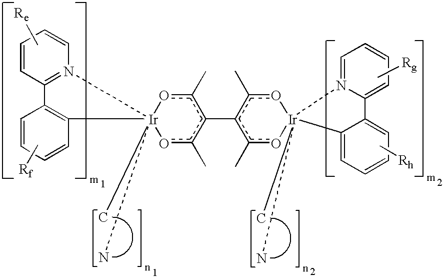
wherein
(C—N) is a substituted or unsubstituted cyclometallated non-emissive ligand;
m has a value of 1 or 2;
(m₁+n₁) is 2; (m₂+n₂) is 2;
each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group;
additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R.

51. A compound of claim 50, wherein m₁ is 2 and n₁ is zero.

52. A compound of claim 51, wherein m₂ is 2 and n₂ is zero.

53. The compound of claim 52, having the structure:

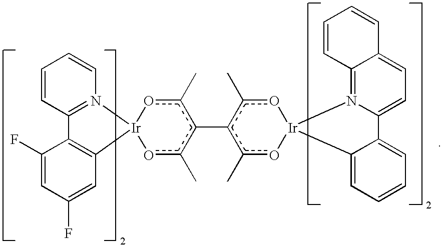

54. An organic light emitting device, comprising:
an anode, a cathode, and an emissive layer disposed between and electrically connected to the anode and the cathode, wherein the emissive layer further comprises a compound, comprising:
a first metal center and a second metal center, wherein each metal has an atomic weight greater than 40; and
a bridging ligand coordinated to the first metal center and the second metal center; and
at least one photoactive ligand bound to the first metal center, and at least one photoactive ligand bound to the second metal center; and
wherein the transition dipole moment of the first photoactive ligand is orthogonal to the transition dipole moment of the second photoactive ligand.

55. The device of claim 54, wherein at least one photoactive ligand has a triplet energy corresponding to a wavelength less than 480 nm.

56. The device of claim 54, wherein at least one photoactive ligand has a triplet energy corresponding to a wavelength of 550-600 nm.

57. The device of claim 56, wherein at least one photoactive ligand has a triplet energy corresponding to a wavelength less than 480 nm.

58. The device of claim 54, wherein at least one photoactive ligand has a triplet energy corresponding to a wavelength of 500-520 nm.

59. The device of claim 54, wherein at least one photoactive ligand has a triplet energy corresponding to a wavelength greater than 590 nm.

60. The device of claim 54, wherein the first metal is Pt.

61. The device of claim 60, wherein the second metal is Pt.

62. The device of claim 61, wherein the bridging ligand comprises the structure:

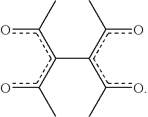

63. The device of claim 62, having the structure: 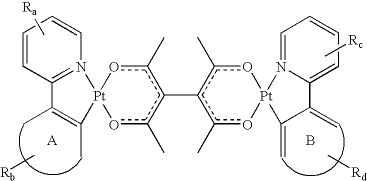
wherein
ring A and ring B are each independently an aromatic heterocyclic or fused aromatic heterocyclic ring;
each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group;
additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R.

64. The device of claim 63, having the structure:

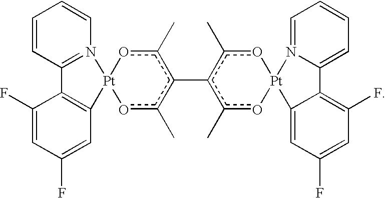

65. The device of claim 63, having the structure:

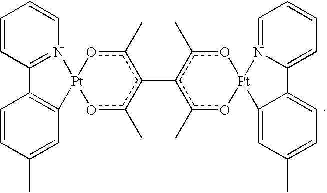

66. The device of claim 63, having the structure:

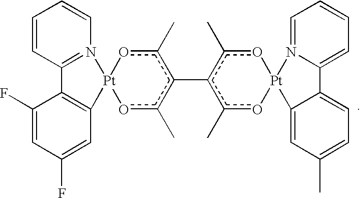

67. The device of claim 63, having the structure:

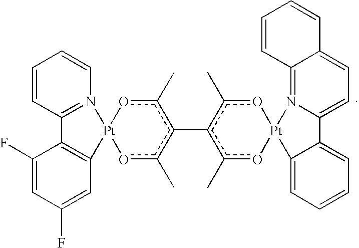

68. The device of claim 63, having the structure:

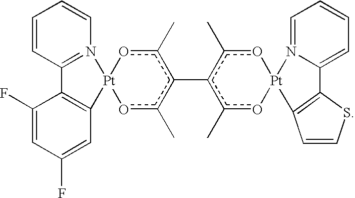

69. The device of claim 63, having the structure:

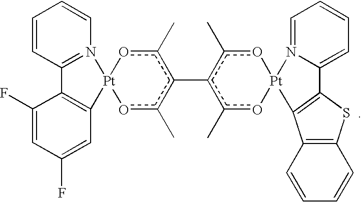

70. The device of claim 63, having the structure:

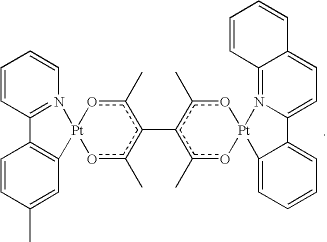

71. The device of claim 54, wherein the device is incorporated into a consumer product.

72. An organic light emitting device, comprising:
an anode, a cathode, and an emissive layer disposed between and electrically connected to the anode and the cathode, wherein the emissive layer further comprises a compound, comprising:
a first metal center and a second metal center, wherein each metal has an atomic weight greater than 40;
a bridging ligand coordinated to the first metal center and the second metal; and
at least one photoactive ligand bound to the first metal center, and at least one photoactive ligand bound to the second metal center; and
wherein the first metal center and the atoms of the bridging ligand that are coordinated to the first metal center define a first plane, and the second metal center and the atoms of the bridging ligand that are coordinated to the second metal center define a second plane, and wherein the first plane and the second plane form an angle that is between about 80 degrees and 100 degrees.

73. The device of claim 72, wherein at least one photoactive ligand has a triplet energy corresponding to a wavelength less than 480 nm.

74. The device of claim 72, wherein at least one photoactive ligand has a triplet energy corresponding to a wavelength of 550-600 nm.

75. The device of claim 74, wherein at least one photoactive ligand has a triplet energy corresponding to a wavelength less than 480 nm.

76. The device of claim 72, wherein at least one photoactive ligand has a triplet energy corresponding to a wavelength of 500-520 nm.

77. The device of claim 72, wherein at least one photoactive ligand has a triplet energy corresponding to a wavelength greater than 590 nm.

78. The device of claim 72, wherein the bridging ligand comprises the structure:

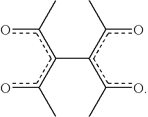

79. The device of claim 78, wherein the first metal is Pt.

80. The device of claim 72, wherein the device is incorporated into a consumer product.

81. An organic light emitting device, comprising:
an anode, a cathode, and an emissive layer disposed between and electrically connected to the anode and the cathode, wherein the emissive layer further comprises a compound, comprising:
a first metal center and a second metal center, wherein each metal has an atomic weight greater than 40;
a bridging ligand coordinated to the first metal center and the second metal center further comprising the structure 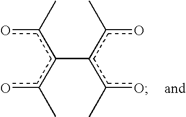
at least one photoactive ligand bound to the first metal center, and at least one photoactive ligand bound to the second metal center.

82. The device of claim 81, wherein the first metal and the second metal are the same metal.

83. The device of claim 82, wherein the first metal is Ir.

84. The device of claim 83, having the structure: 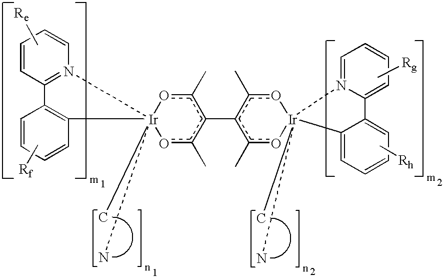
wherein
(C—N) is a substituted or unsubstituted cyclometallated non-emissive ligand;
m has a value of 1 or 2;
(m₁+n₁) is 2; (m₂+n₂) is 2;
each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group;
additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R.

85. The device of claim 84, wherein m₁ is 2 and n₁ is zero.

86. The device of claim 85, wherein m₂ is 2 and n₂ zero.

87. The device of claim 86, having the structure:

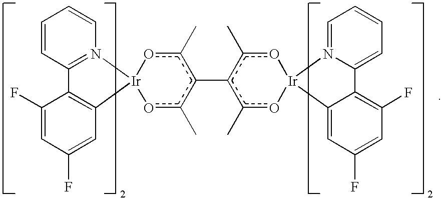

88. The device of claim 81, wherein the device is incorporated into a consumer product.

89. An organic light emitting device, comprising:
an anode, a cathode, and an emissive layer disposed between and electrically connected to the anode and the cathode, wherein the emissive layer further comprises a compound, comprising:
a first metal center and a second metal center, wherein each metal has an atomic weight greater than 40;
a polymer or small molecule coordinated to the first metal center and the second metal; and
at least one photoactive ligand bound to the first metal center, and at least one photoactive ligand bound to the second metal center, wherein the first metal-ligand complex is different from the second metal-ligand complex.

90. The device of claim 89, wherein the first metal is Pt.

91. The device of claim 89, wherein the first metal is Ir.

92. The device of claim 89, wherein at least one photoactive ligand has a triplet energy corresponding to a wavelength less than 480 nm.

93. The device of claim 89, wherein at least one photoactive ligand has a triplet energy corresponding to a wavelength of 550-600 nm.

94. The device of claim 93, wherein at least one photoactive ligand has a triplet energy corresponding to a wavelength less than 480 nm.

95. The device of claim 89, wherein at least one photoactive ligand has a triplet energy corresponding to a wavelength of 500-520 nm.

96. The device of claim 89, wherein at least one photoactive ligand has a triplet energy corresponding to a wavelength greater than 590 nm.

97. The device of claim 89, wherein the polymer or small molecule comprises the structure:

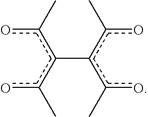

98. The device of claim 97, wherein the first metal is Pt.

99. The device of claim 98, wherein the second metal is Ir.

100. The device of claim 99, having the structure: 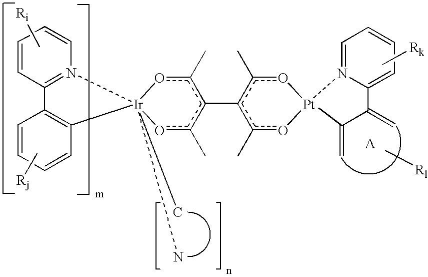
wherein
(C—N) is a substituted or unsubstituted cyclometallated non-emissive ligand;
m is a value from 1 to 3;
m+n is 3;
ring A is an aromatic heterocyclic or fused aromatic heterocyclic ring;
each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group;
additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R.

101. The device of claim 100, wherein m is 2 and n is zero.

102. The device of claim 101, having the structure:

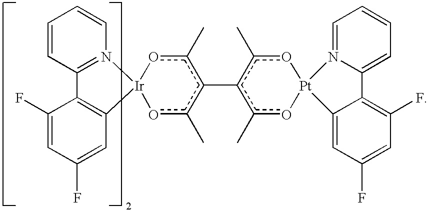

103. The device of claim 101, having the structure:

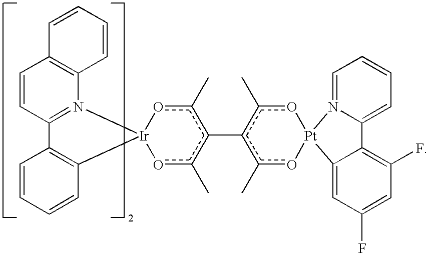

104. The device of claim 101, having the structure:

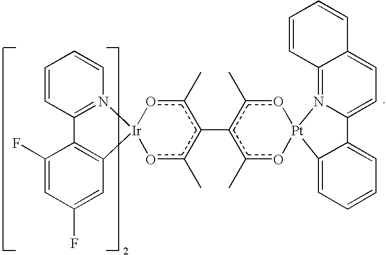

105. The device of claim 94, wherein the first metal is Ir.

106. The device of claim 102, having the structure: 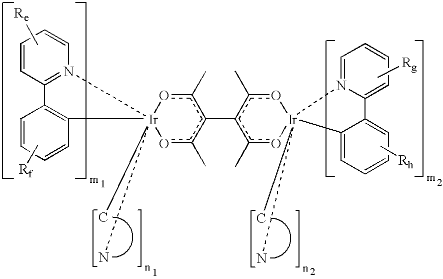
wherein
(C—N) is a substituted or unsubstituted cyclometallated non-emissive ligand;
m has a value of 1 or 2;
(m₁+nₗ) is 2; (m₂+n₂) is 2;
each R is independently selected from hydrogen, alkyl, alkenyl, alkynyl, alkylaryl, CN, CF₃, CO₂R, C(O)R, NR₂, NO₂, OR, halo, aryl heteroaryl, substituted aryl, substituted heteroaryl, or a heterocyclic group;
additionally or alternatively, any two adjacent substituted positions together form, independently, a fused 4- to 7-member cyclic group, wherein said cyclic group is cycloalkyl, cycloheteroalkyl, aryl, heteroaryl, and wherein the 4- to 7-member cyclic group may be optionally substituted with substituent R.

107. A device of claim 106, wherein m₁ is 2 and n₁ is zero.

108. A device of claim 107, wherein m₂ is 2 and n₂ is zero.

109. The device of claim 108, having the structure:

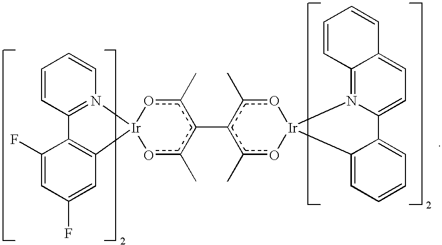

110. The device of claim 89, wherein the device is incorporated into a consumer product.
